(19) United States
(12) Patent Application Publication
(10) Pub. No.: US 2026/0312947 A1
(43) Pub. Date: Oct. 8, 2026

(54) Secure Data Directory with Double Authentication

(71) Applicant: Dell Products L.P., Round Rock, TX (US)

(72) Inventors: Shiv S. Kumar, Pune (IN); Kaushik Gupta, Pune (IN)

(21) Appl. No.: 19/170,939

(22) Filed: Apr. 4, 2025

(51) Int. Cl. H04L 9/40

(52) U.S. Cl. CPC H04L 63/083

(57) ABSTRACT

A system can receive a request that is associated with a user account to write a file that comprises a first passphrase to a directory, wherein the directory stores a second file that comprises a second passphrase. The system can, based on determining that an identification of the user account is omitted from a multifactor authentication extended attribute of the directory, compare the first passphrase and the second passphrase to produce a result. The system can, based on the result indicating that the first passphrase matches the second passphrase, add the identification of the user account to the multifactor authentication extended attribute of the directory. The system can permit operations on the directory via the user account based on the multifactor authentication extended attribute comprising the identification of the user account.

### BACKGROUND

Computer data can require authorization for a particular user account to access it.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive a request that is associated with a user account to write a file that comprises a first passphrase to a directory, wherein the directory stores a second file that comprises a second passphrase. The system can, based on determining that an identification of the user account is omitted from a multifactor authentication extended attribute of the directory, compare the first passphrase and the second passphrase to produce a result. The system can, based on the result indicating that the first passphrase matches the second passphrase, add the identification of the user account to the multifactor authentication extended attribute of the directory. The system can permit operations on the directory via the user account based on the multifactor authentication extended attribute comprising the identification of the user account.

An example method can comprise, based on determining that an identification of a user account is omitted from a multifactor authentication extended attribute of a directory, comparing, by a system comprising at least one processor, a first passphrase of a first file and a second passphrase of a second file to produce a result, wherein the first file is identified by a request associated with the user account to write the first file to the directory, and wherein the second file is stored in the directory. The method can further comprise, based on the result indicating that the first passphrase matches the second passphrase, adding, by the system, the identification of the user account to the multifactor authentication extended attribute of the directory. The method can further comprise permitting, by the system, operations on the directory via the user account based on the multifactor authentication extended attribute comprising the identification of the user account.

An example non-transitory computer-readable medium can comprise instructions that, in response to execution, cause a system comprising a processor to perform operations. These operations can comprise, based on determining that an identification of a user account is omitted from an extended attribute of a directory, comparing a first passphrase of a first file and a second passphrase of a second file to produce a result, wherein the first file is identified by a request associated with the user account to write the first file to the directory, and wherein the second file is stored in the directory. These operations can further comprise, based on the result indicating that the first passphrase matches the second passphrase, adding the identification of the user account to the extended attribute of the directory, and enabling operations, initiated from the user account, on the directory based on the extended attribute comprising the identification of the user account.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate secure data directory with double authentication, in accordance with an embodiment of this disclosure;

FIG. 2 illustrates an example system architecture for creating a MFA directory, and that can facilitate secure data directory with double authentication, in accordance with an embodiment of this disclosure;

FIG. 3 illustrates an example process flow for creating a MFA directory, and that can facilitate secure data directory with double authentication, in accordance with an embodiment of this disclosure;

FIG. 4 illustrates an example system architecture for accessing a file in a MFA directory, and that can facilitate secure data directory with double authentication, in accordance with an embodiment of this disclosure;

FIG. 5 illustrates an example process flow for assessing whether a user is in MFA_Users, and that can facilitate secure data directory with double authentication, in accordance with an embodiment of this disclosure;

FIG. 6 illustrates an example process flow for assessing whether a user account provided the correct passphrase, and can facilitate secure data directory with double authentication, in accordance with an embodiment of this disclosure;

FIG. 7 illustrates an example process flow that can facilitate secure data directory with double authentication, in accordance with an embodiment of this disclosure;

FIG. 8 illustrates another example process flow that can facilitate secure data directory with double authentication, in accordance with an embodiment of this disclosure;

FIG. 9 illustrates another example process flow that can facilitate secure data directory with double authentication, in accordance with an embodiment of this disclosure; and

FIG. 10 illustrates an example block diagram of a computer operable to execute an embodiment of this disclosure.

### DETAILED DESCRIPTION

### Overview

In a computer storage system, it can be that some data has a high value, and a storage administrator wants to protect it (e.g., protect a directory in which that data is located). One approach to address this can be to implement multi-factored authentication to files. Where prior approaches address multi-factored authentication to files, the present techniques implement multi-factored authentication to files in a different way.

The present techniques can generally comprise adding a layer on top of protocol authentication. Additional authentication can be facilitated by writing a special file (comprising a passphrase) to a given directory by a user account. Where a supplied passphrase matches the passphrase stored in the file in the directory, then further input/output (I/O) operations to that directory can be allowed.

The use of the passphrase file along with other authentication can be referred to as multifactor authentication (MFA).

Activating multifactor authentication for a directory can comprise:

An interface (e.g., a command line interface (CLI)) that is configured to receive user input data to indicate to a system that a particular directory is to implement multifactor authentication.

In response to a directory being classified for multifactor authentication, metadata (e.g., an extended attribute, which can comprise a key value pair and that is stored separately from the directory or file that it refers to) for the directory can be created (e.g., “MFA_Users”). MFA_Users can comprise a list of user account identifiers (ids) that are authorized to perform I/O on the directory.

Additionally, a passphrase file can be generated in that directory, and it can be indicated to an administrator (e.g., a secure admin) that subsequent I/O operations on the directory and files in the directory are permitted where the user account first provides the passphrase in the file for additional authentication.

It can be that the passphrase file is not editable by a user account.

Distribution and regeneration of a passphrase can be performed as follows. After a directory is enabled as a secure directory, a passphrase file can be generated. It can be that the file can only be seen by a user account with a status of secure-admin. The admin can distribute the corresponding passphrase to user accounts.

There can be a facility to invalidate the passphrase and generate a new one for a directory. In some examples, regeneration can be performed periodically, or on demand by user input data from a secure-admin.

### Example Architechture, ETC

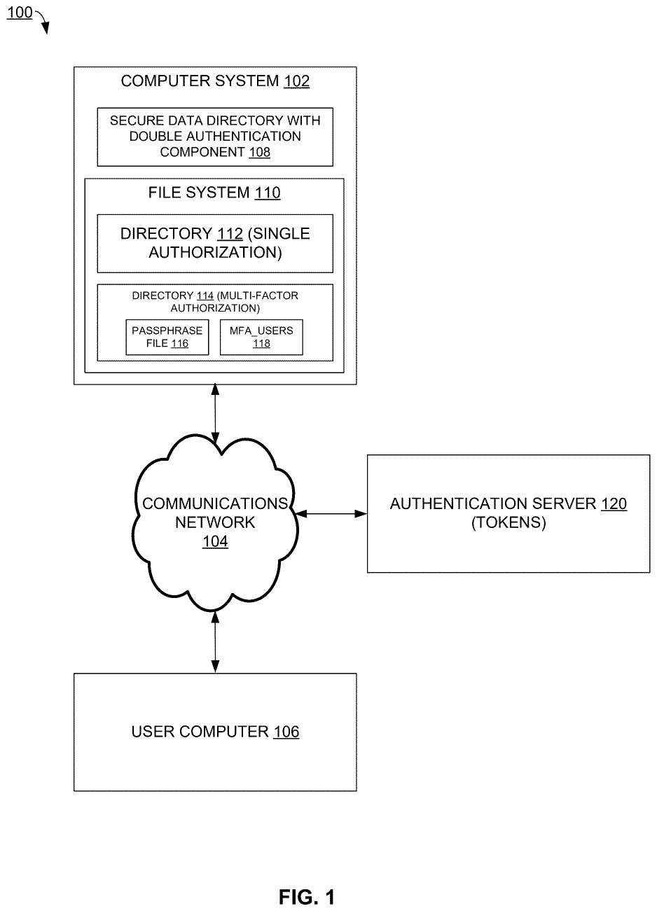

FIG. 1 illustrates an example system architecture 100 that can facilitate secure data directory with double authentication, in accordance with an embodiment of this disclosure.

System architecture 100 comprises computer system 102, communications network 104, user computer 106, and authentication server 120 (tokens). In turn, computer system 102 comprises secure data directory with double authentication component 108, file system 110, directory 112 (single authorization), directory 114 (multi-factor authorization), passphrase file 116, and MFA_Users 118.

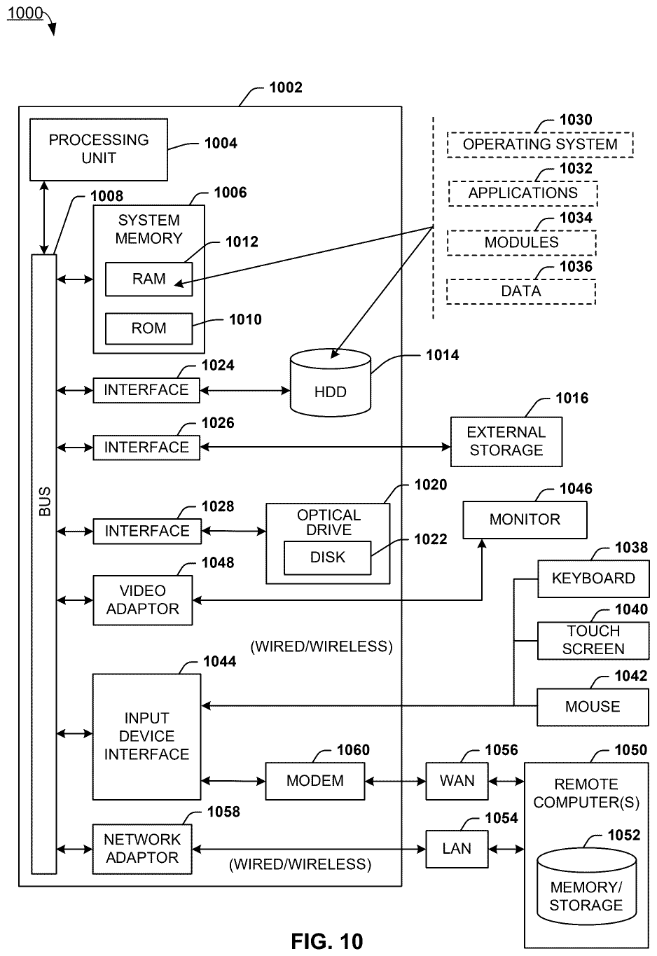

Each of computer system 102, user computer 106, and/or authentication server 120 (tokens) can be implemented with part(s) of computing environment 1000 of FIG. 10. Communications network 104 can comprise a computer communications network, such as the Internet.

Computer system 102 can host file system 110, which can store computer files that are accessible to a user account of user computer 106 via communications network 104. To access those files, the user account can obtain an authorization token from authentication server 120 (tokens). To do this, the user account can supply, e.g., a valid username and password for file system 110 and/or computer system 102 to authentication server 120 (tokens).

With this token, the user account can access files in directory 112 (single authorization). For directory 114 (MFA), it can be that the user account must be first authorized via this token, and then also authorized by a passphrase file. The user account can write a passphrase file to directory 114 (MFA), and secure data directory with double authentication component 108 can facilitate comparing this with passphrase file 116. Where the two passphrases match, secure data directory with double authentication component 108 can facilitate adding an identification of the user account to MFA_Users 118, and the user account can be permitted to make file operations in directory 114 (MFA).

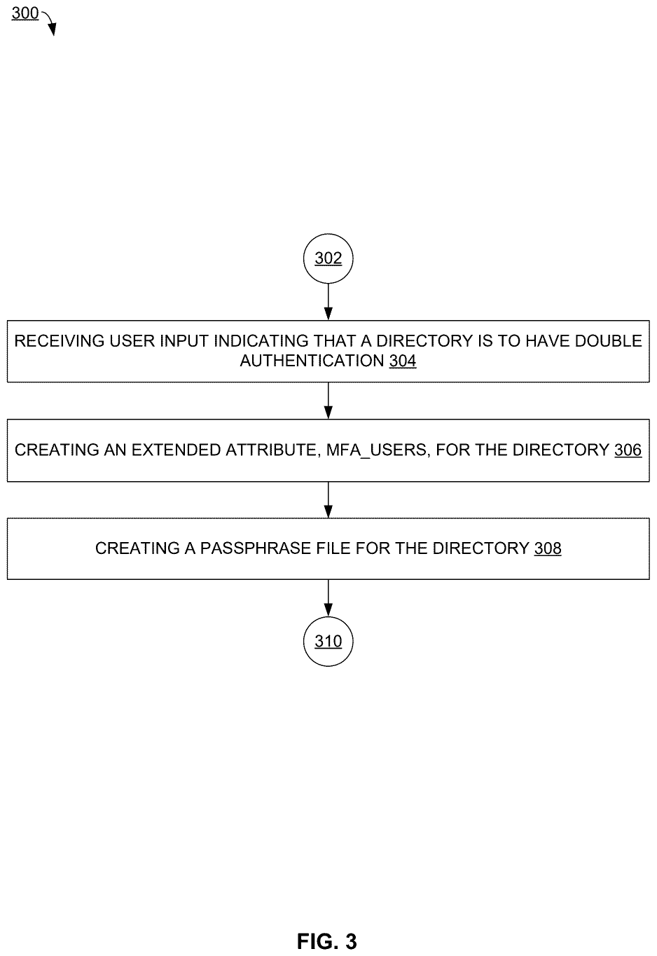

In some examples, secure data directory with double authentication component 108 can implement part(s) of the process flows of FIGS. 3 and/or 5-9 to implement secure data directory with double authentication.

It can be appreciated that system architecture 100 is one example system architecture for secure data directory with double authentication, and that there can be other system architectures that facilitate secure data directory with double authentication.

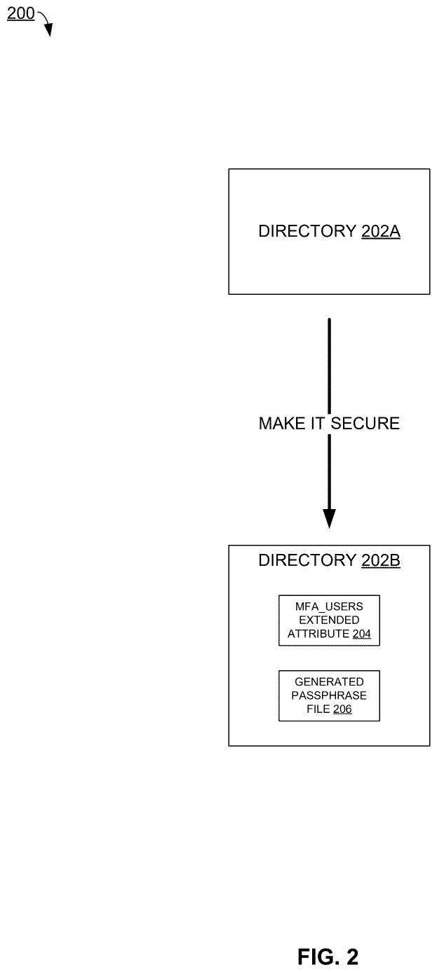

FIG. 2 illustrates an example system architecture 200 for creating a MFA directory, and that can facilitate secure data directory with double authentication, in accordance with an embodiment of this disclosure. In some examples, part(s) of system architecture 200 can be used by part(s) of system architecture 100 of FIG. 1 to facilitate secure data directory with double authentication.

System architecture 200 comprises directory 202A, directory 202B, MFA_Users extended attribute 204, and generated passphrase file 206.

Directory 202A represents a directory before the present techniques are applied to it, and directory 202B represents that same directory after the present techniques are applied to it.

FIG. 3 illustrates an example process flow 300 for creating a MFA directory, and that can facilitate secure data directory with double authentication, in accordance with an embodiment of this disclosure. In some examples, one or more embodiments of process flow 300 can be implemented by secure data directory with double authentication component 108 of FIG. 1, or computing environment 1000 of FIG. 10.

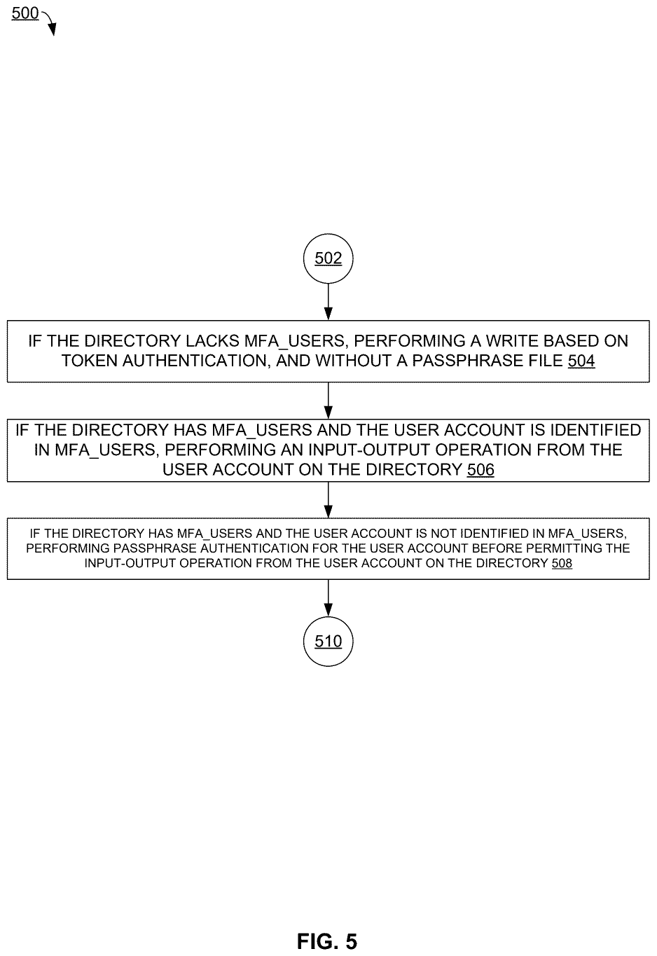

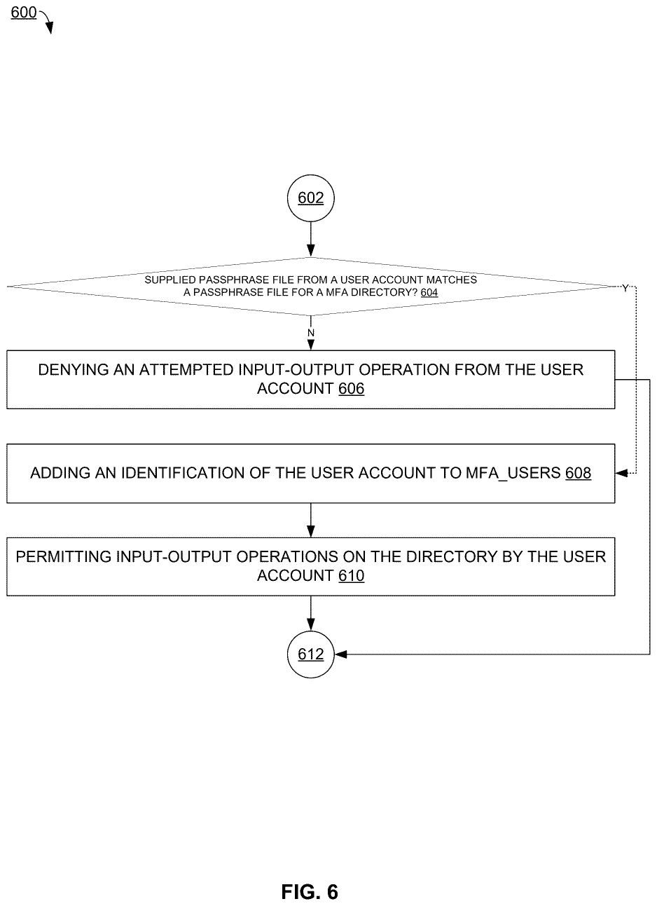

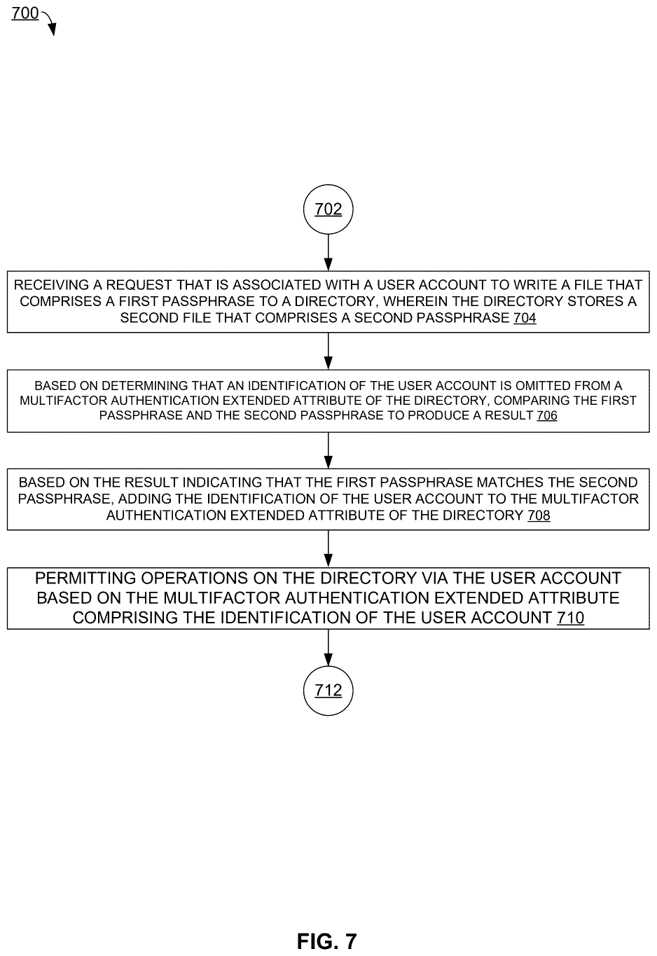

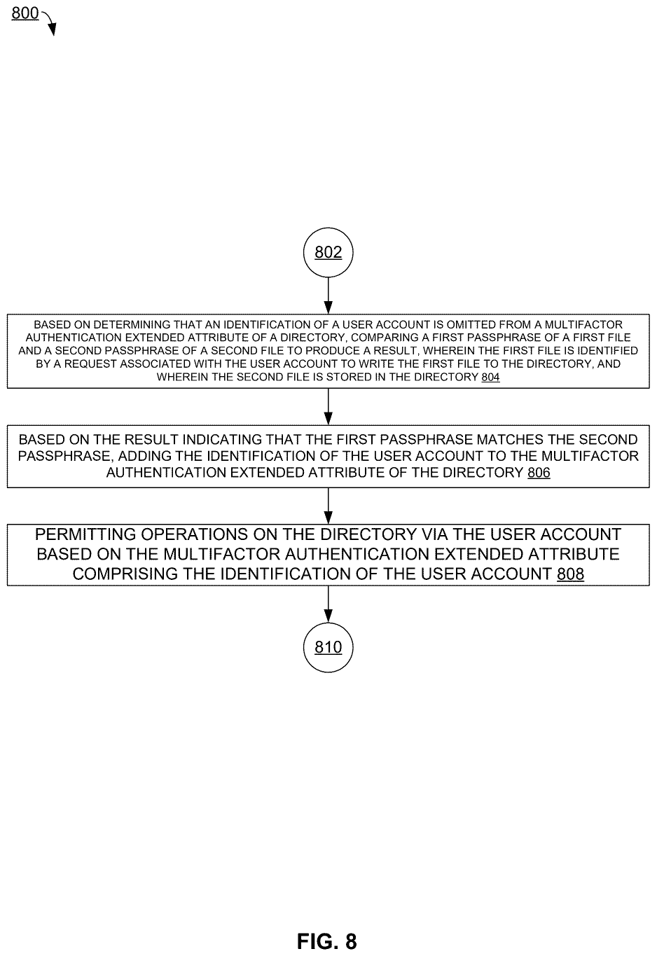

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 500 of FIG. 5, process flow 600 of FIG. 6, process flow 700 of FIG. 7, process flow 800 of FIG. 8, and/or process flow 1000 of FIG. 10.

Process flow 300 begins with 302, and moves to operation 304.

Operation 304 depicts receiving user input indicating that a directory is to have double authentication.

After operation 304, process flow 300 moves to operation 306.

Operation 306 depicts creating an extended attribute, MFA_Users, for the directory.

After operation 306, process flow 300 moves to operation 308.

Operation 308 depicts creating a passphrase file for the directory.

After operation 308, process flow 300 moves to 310, where process flow 300 ends.

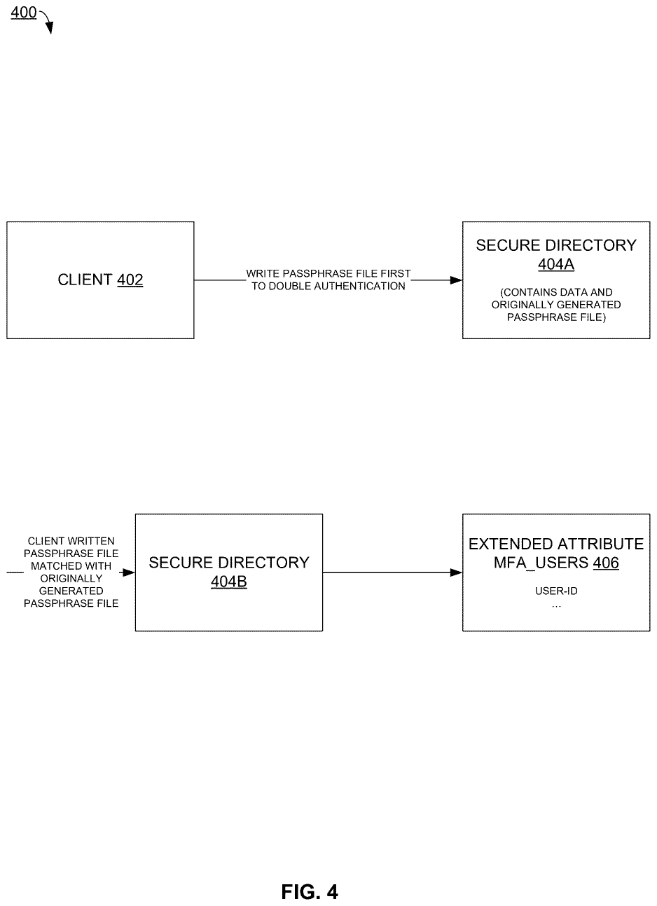

FIG. 4 illustrates an example system architecture 400 for accessing a file in a MFA directory, and that can facilitate secure data directory with double authentication, in accordance with an embodiment of this disclosure. In some examples, part(s) of system architecture 200 can be used by part(s) of system architecture 100 of FIG. 1 to facilitate secure data directory with double authentication.

System architecture 400 comprises client 402, secure directory 404A, secure directory 404B, and extended attribute MFA_Users 406.

In example 400, where client 402 writes the correct passphrase file to secure directory 404A, then secure directory 404B illustrates a later point in time where a user-id corresponding to client 402 is stored in extended attribute MFA_Users 406.

### Excess Process Flows

FIG. 5 illustrates an example process flow 500 for assessing whether a user is in MFA_Users, and that can facilitate secure data directory with double authentication, in accordance with an embodiment of this disclosure. In some examples, one or more embodiments of process flow 500 can be implemented by secure data directory with double authentication component 108 of FIG. 1, or computing environment 1000 of FIG. 10.

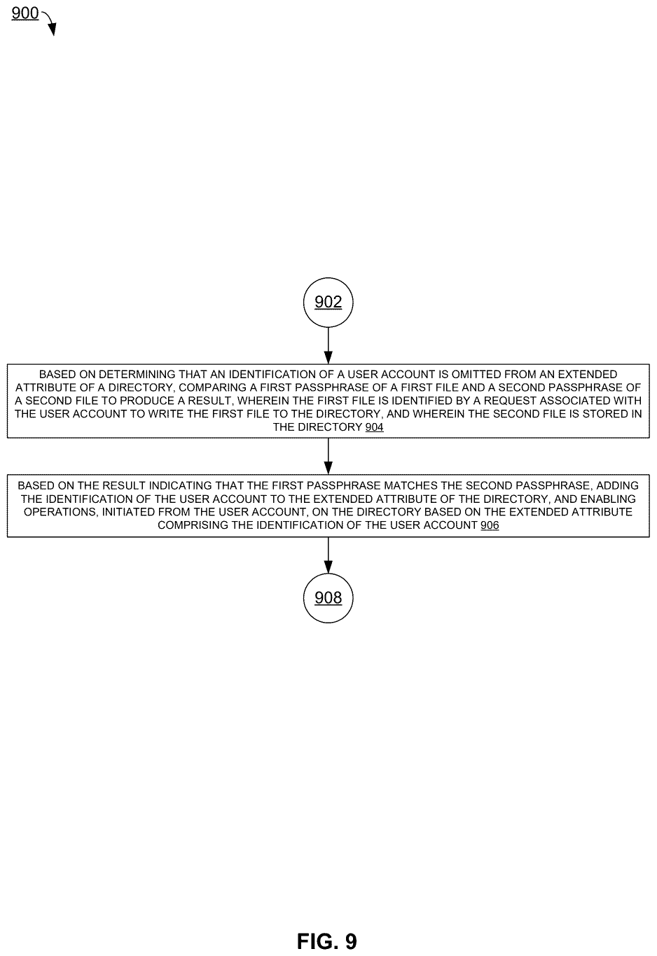

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 300 of FIG. 3, process flow 600 of FIG. 6, process flow 700 of FIG. 7, process flow 800 of FIG. 8, and/or process flow 900 of FIG. 9.

Process flow 500 begins with 502, and moves to operation 504.

Operation 504 depicts, if the directory lacks MFA_Users, performing a write based on token authentication, and without a passphrase file.

After operation 504, process flow 500 moves to operation 506.

Operation 506 depicts, if the directory has MFA_Users and the user account is identified in MFA_Users, performing an input-output operation from the user account on the directory.

After operation 506, process flow 500 moves to operation 508.

Operation 508 depicts, if the directory has MFA_Users and the user account is not identified in MFA_Users, performing passphrase authentication for the user account before permitting the input-output operation from the user account on the directory.

After operation 508, process flow 500 moves to 510, where process flow 500 ends.

In some examples, process flow 500 and process flow 600 of FIG. 6 can be implemented together to effectuate the following.

For a write to a directory, if the directory to which the write is to occur lacks a MFA_Users extended attribute, then perform the write based on authentication without the passphrase file.

If the user that is performing I/O for that directory is part of MFA_Users, then allow the intended I/O.

If the user that is performing I/O for that directory is not part of MFA_Users, then
Allow a write for maximum size of a 1 megabyte (MB) file (where this size can indicate that it is a passphrase file);
If the written passphrase file matches with the original passphrase file (that was generated and stored in the directory when MFA was enabled for this directory),
   Add the user account associated with writing the file to the extended attribute MFA_Users;
   Now, further I/O can be permitted for that user account;
   This user account can be removed from the extended attribute MFA_Users after a specified amount of time (e.g., N minutes);
   This can result in an authentication being valid for only a defined amount of time.
   If the user account attempts to perform I/O after the expiration of the defined amount of time, it can be that the user account will first reauthenticate.
If the written passphrase file does not match with the original passphrase file,
   An access denied result is returned for the attempted I/O; and
   The user's written passphrase file can be deleted.

FIG. 6 illustrates an example process flow 600 for assessing whether a user account provided the correct passphrase, and that can facilitate secure data directory with double authentication, in accordance with an embodiment of this disclosure. In some examples, one or more embodiments of process flow 600 can be implemented by secure data directory with double authentication component 108 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 300 of FIG. 3, process flow 500 of FIG. 5, process flow 700 of FIG. 7, process flow 800 of FIG. 8, and/or process flow 900 of FIG. 9.

Process flow 600 begins with 602, and moves to operation 604.

Operation 604 depicts determining whether a supplied passphrase file from a user account matches a passphrase file for a MFA directory.

Where in operation 604 it is determined that the supplied passphrase file from the user account matches the passphrase file for the MFA directory, process flow 600 moves to operation 608. Instead, where in operation 604 it is determined that the supplied passphrase file from the user account differs from the passphrase file for the MFA directory, process flow 600 moves to operation 606.

Operation 606 is reached from operation 604 where it is determined that the supplied passphrase file from the user account differs from the passphrase file for the MFA directory. Operation 606 depicts denying an attempted input-output operation from the user account.

After operation 606, process flow 600 moves to 612, where process flow 600 ends.

Operation 608 is reached from operation 604 where it is determined that the supplied passphrase file from the user account matches the passphrase file for the MFA directory. Operation 608 depicts adding an identification of the user account to MFA_Users.

After operation 608, process flow 600 moves to operation 610.

Operation 610 depicts permitting input-output operations on the directory by the user account.

After Operation 610, Process Flow 600 Moves to 612, Where Process Flow 600 ends.

FIG. 7 illustrates an example process flow 700 that can facilitate secure data directory with double authentication, in accordance with an embodiment of this disclosure. In some examples, one or more embodiments of process flow 700 can be implemented by secure data directory with double authentication component 108 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 300 of FIG. 3, process flow 500 of FIG. 5, process flow 600 of FIG. 6, process flow 700 of FIG. 7, process flow 800 of FIG. 8, and/or process flow 900 of FIG. 9.

Process flow 700 begins with 702, and moves to operation 704.

Operation 704 depicts receiving a request that is associated with a user account to write a file that comprises a first passphrase to a directory, wherein the directory stores a second file that comprises a second passphrase. That is, where a directory is enabled for MFA, a user account can write its passphrase (as stored in a file) to that directory, as a way to obtain further access to the directory.

A directory can be deemed to be enabled for MFA where accessing it involves two types of authentication: an authentication token, as well as a correct passphrase file. An authentication token can generally comprise a credential that is obtained by a user account and that is used to verify and grant access to a file system. A user account can request access to a file system, and an authentication server can generate a token after verifying user account credentials, such as a username and password, an application programming interface (API) key, and/or a certificate. That token can then be used instead of a password as the user account accesses files in the file system. It can be that the token is valid for a specified amount of time, and for specified operations (e.g., from read, write, and delete operations).

In some examples, the receiving of the request that is associated with the user account to write the file that comprises the first passphrase to the directory comprises determining that the file satisfies a size criterion. That is, there can be a requirement that a passphrase file not be too large (e.g., be no larger than 1 MB).

After operation 704, process flow 700 moves to operation 706.

Operation 706 depicts, based on determining that an identification of the user account is omitted from a multifactor authentication extended attribute of the directory, comparing the first passphrase and the second passphrase to produce a result. That is, where the user account is not already in MFA_Users, the supplied passphrase can be compared with the stored passphrase for the directory.

After operation 706, process flow 700 moves to operation 708.

Operation 708 depicts, based on the result indicating that the first passphrase matches the second passphrase, adding the identification of the user account to the multifactor authentication extended attribute of the directory. That is, where the supplied passphrase matches the stored passphrase for the directory, an identification of the user account can be added to MFA_Users.

In some examples, once a comparison between a user-account supplied passphrase file and the passphrase file for a directory occurs, the user-account supplied passphrase file can be deleted.

This comparison can occur after a CLOSE operation occurs for writing the user account's passphrase file. There can be a callback( ) operation for a CLOSE after writing a file, and this callback can trigger the comparison.

After operation 708, process flow 700 moves to operation 710.

Operation 710 depicts permitting operations on the directory via the user account based on the multifactor authentication extended attribute comprising the identification of the user account. That is, the user account can ow be permitted to perform further operations on the directory because it is identified in MFA_Users.

In some examples, the request is a first request, the user account is a first account, wherein the identification is a first identification, operation 710 comprises, based on receiving a second request that is associated with a second user account to access the directory, and based on the multifactor authentication extended attribute comprising a second identification of the second user account, permitting the second request. That is, a user account can skip the step of providing a passphrase where that user account is already identified in MFA_Users.

In some examples, the request is a first request, the user account is a first account, wherein the file is a first file, the identification is a first identification, and operation 710 comprises, based on receiving a second request that is associated with a second user account to write a third file to the directory, based on the multifactor authentication extended attribute omitting a second identification of the second user account, and based on determining that a size of the third file fails to satisfy a size criterion, rejecting the second request. That is, there can be a requirement that a passphrase file not be too large (e.g., be no larger than 1 MB). Where the passphrase file is too large, writing it can be rejected.

In some examples, operation 710 comprises removing the identification of the user account from the multifactor authentication extended attribute after a defined amount of time.

In some examples, the file is a first file, and operation 710 comprises, after the removing of the identification of the user account from the multifactor authentication extended attribute, re-adding the identification of the user account from the multifactor authentication extended attribute based on a third file, written via the user account, that comprises the first file or another file, and wherein the third file comprises the first passphrase.

That is, where a user account is added to MFA_Users, this can be for a finite amount of time (e.g., 1 hour) and the user account can be removed from MFA_Users after the expiration of that amount of time. Where this occurs, a user account can again authenticate (via providing a passphrase file), and be again added to MFA_Users.

In some examples, the request is a first request, the user account is a first account, the file is a first file, the identification is a first identification, and operation 710 comprises, based on receiving a second request that is associated with a second user account to write a third file that comprises a third passphrase to the directory, based on the multifactor authentication extended attribute omitting a second identification of the second user account, and based on determining that the third passphrase differs from the second passphrase, rejecting the second request. That is, an authentication request can be rejected where the user account supplies the wrong passphrase for a given directory.

After operation 710, process flow 700 moves to 712, where process flow 700 ends.

FIG. 8 illustrates another example process flow 800 that can facilitate secure data directory with double authentication, in accordance with an embodiment of this disclosure. In some examples, one or more embodiments of process flow 800 can be implemented by secure data directory with double authentication component 108 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 300 of FIG. 3, process flow 500 of FIG. 5, process flow 600 of FIG. 6, process flow 700 of FIG. 7, and/or process flow 900 of FIG. 9.

Process flow 800 begins with 802, and moves to operation 804.

Operation 804 depicts, based on determining that an identification of a user account is omitted from a multifactor authentication extended attribute of a directory, comparing a first passphrase of a first file and a second passphrase of a second file to produce a result, wherein the first file is identified by a request associated with the user account to write the first file to the directory, and wherein the second file is stored in the directory. In some examples, operation 804 can be implemented in a similar manner as operations 704-706 of FIG. 7.

In some examples, operation 804 comprises elevating the directory from a first status to a second status, where the second status indicates a use of passphrases for access, and where the first status omits the use of passphrases for access.

In some examples, the elevating is performed based on receiving user input data indicative of elevating the directory.

In some examples, operation 804 comprises creating the second file based on the elevating.

In some examples, operation 804 comprises, creating the multifactor authentication extended attribute based on the elevating.

That is, a directory can be changed from one authentication system to another, where the change results in using passphrases. This can be done in response to user input indicating to elevate the directory for MFA. As part of making a directory MFA, a corresponding passphrase file for the directory can be created. As part of making a directory MFA, MFA_Users for that directory can be created.

After operation 804, process flow 800 moves to operation 806.

Operation 806 depicts, based on the result indicating that the first passphrase matches the second passphrase, adding the identification of the user account to the multifactor authentication extended attribute of the directory. In some examples, operation 806 can be implemented in a similar manner as operation 708 of FIG. 7.

After operation 806, process flow 800 moves to operation 808.

Operation 808 depicts permitting operations on the directory via the user account based on the multifactor authentication extended attribute comprising the identification of the user account. In some examples, operation 808 can be implemented in a similar manner as operation 710 of FIG. 7.

In some examples, operation 808 comprises changing the second passphrase from a first value to a second value.

In some examples, the changing of the second passphrase from the first value to the second value comprises performing iterations of the changing of the second passphrase on a schedule.

In some examples, the changing of the second passphrase from the first value to the second value is performed based on receiving user input data indicative of the changing of the second passphrase.

That is, it can be that a directory's passphrase can change over time. In some examples, this can be done automatically on a schedule. In other examples this can be done on demand. It can be that, when a passphrase is changed, all user accounts currently in MFA_Users for that directory are removed from MFA_Users and must reauthenticate with the new passphrase to access that directory. In other examples, it can be that user accounts currently in MFA_Users remain in MFA_Users (e.g., until they are removed after the expiration of a certain amount of time).

After operation 808, process flow 800 moves to 810, where process flow 800 ends.

FIG. 9 illustrates another example process flow 900 that can facilitate secure data directory with double authentication, in accordance with an embodiment of this disclosure. In some examples, one or more embodiments of process flow 900 can be implemented by secure data directory with double authentication component 108 of FIG. 1, or computing environment 900 of FIG. 9.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 300 of FIG. 3, process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts, based on determining that an identification of a user account is omitted from an extended attribute of a directory, comparing a first passphrase of a first file and a second passphrase of a second file to produce a result, wherein the first file is identified by a request associated with the user account to write the first file to the directory, and wherein the second file is stored in the directory. In some examples, operation 904 can be implemented in a similar manner as operations 704-706 of FIG. 7.

In some examples, the second file is uneditable from the user account or another user account that is different from the user account. That is, it can be that no user account has authorization to edit a passphrase file for a directory (though, in some examples, it can be that the passphrase can be changed, such as on a schedule, or on demand).

In some examples, the second file is viewable by a second user account with a secure administrator status, and wherein the second file is hidden from the user account. That is, it can be that the passphrase file itself for a directory is only visible to user accounts with a secure-admin status.

In some examples, the second file is stored in a known location in the directory. That is, a directory's passphrase file can have a standardized name so that a version of it can be located within each directory for which MFA is implemented.

In some examples, the directory is a first directory, and a second directory is protected with a third passphrase that differs from the second passphrase. That is, each directory for which MFA is implemented can have its own passphrase, and these passphrases can be different (in some examples, they can be the same for at least some directories).

After operation 904, process flow 900 moves to operation 906.

Operation 906 depicts based on the result indicating that the first passphrase matches the second passphrase, adding the identification of the user account to the extended attribute of the directory, and enabling operations, initiated from the user account, on the directory based on the extended attribute comprising the identification of the user account. In some examples, operation 906 can be implemented in a similar manner as operations 708-710 of FIG. 7.

After operation 906, process flow 900 moves to 908, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer system 102, user computer 106, and/or authentication server 120 (tokens).

In some examples, computing environment 1000 can implement one or more embodiments of the process flows of FIGS. 3 and/or 5-9 to facilitate secure data directory with double authentication.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving a request that is associated with a user account to write a file that comprises a first passphrase to a directory, wherein the directory stores a second file that comprises a second passphrase;
based on determining that an identification of the user account is omitted from a multifactor authentication extended attribute of the directory, comparing the first passphrase and the second passphrase to produce a result;
based on the result indicating that the first passphrase matches the second passphrase, adding the identification of the user account to the multifactor authentication extended attribute of the directory; and
permitting operations on the directory via the user account based on the multifactor authentication extended attribute comprising the identification of the user account.

2. The system of claim 1, wherein the request is a first request, wherein the user account is a first account, wherein the identification is a first identification, and wherein the operations further comprise:
based on receiving a second request that is associated with a second user account to access the directory, and based on the multifactor authentication extended attribute comprising a second identification of the second user account, permitting the second request.

3. The system of claim 1, wherein the receiving of the request that is associated with the user account to write the file that comprises the first passphrase to the directory comprises:
determining that the file satisfies a size criterion.

4. The system of claim 1, wherein the request is a first request, wherein the user account is a first account, wherein the file is a first file, wherein the identification is a first identification, and wherein the operations further comprise:
based on receiving a second request that is associated with a second user account to write a third file to the directory, based on the multifactor authentication extended attribute omitting a second identification of the second user account, and based on determining that a size of the third file fails to satisfy a size criterion, rejecting the second request.

5. The system of claim 1, wherein the operations further comprise:
removing the identification of the user account from the multifactor authentication extended attribute after a defined amount of time.

6. The system of claim 1, wherein the file is a first file, and wherein the operations further comprise:
after the removing of the identification of the user account from the multifactor authentication extended attribute, re-adding the identification of the user account from the multifactor authentication extended attribute based on a third file, written via the user account, that comprises the first file or another file, and wherein the third file comprises the first passphrase.

7. The system of claim 1, wherein the request is a first request, wherein the user account is a first account, wherein the file is a first file, wherein the identification is a first identification, and wherein the operations further comprise:
based on receiving a second request that is associated with a second user account to write a third file that comprises a third passphrase to the directory, based on the multifactor authentication extended attribute omitting a second identification of the second user account, and based on determining that the third passphrase differs from the second passphrase, rejecting the second request.

8. A method, comprising:
based on determining that an identification of a user account is omitted from a multifactor authentication extended attribute of a directory, comparing, by a system comprising at least one processor, a first passphrase of a first file and a second passphrase of a second file to produce a result, wherein the first file is identified by a request associated with the user account to write the first file to the directory, and wherein the second file is stored in the directory;
based on the result indicating that the first passphrase matches the second passphrase, adding, by the system, the identification of the user account to the multifactor authentication extended attribute of the directory; and
permitting, by the system, operations on the directory via the user account based on the multifactor authentication extended attribute comprising the identification of the user account.

9. The method of claim 8, further comprising:
changing, by the system, the second passphrase from a first value to a second value.

10. The method of claim 9, wherein the changing of the second passphrase from the first value to the second value comprises:
performing iterations of the changing of the second passphrase on a schedule.

11. The method of claim 9, wherein the changing of the second passphrase from the first value to the second value is performed based on receiving user input data indicative of the changing of the second passphrase.

12. The method of claim 8, further comprising:
elevating, by the system, the directory from a first status to a second status, wherein the second status indicates a use of passphrases for access, and wherein the first status omits the use of passphrases for access.

13. The method of claim 12, wherein the elevating is performed based on receiving user input data indicative of elevating the directory.

14. The method of claim 12, further comprising:
creating, by the system, the second file based on the elevating.

15. The method of claim 12, further comprising:
creating, by the system, the multifactor authentication extended attribute based on the elevating.

16. A non-transitory computer-readable medium comprising instructions that, in response to execution, cause a system comprising at least one processor to perform operations, comprising:
based on determining that an identification of a user account is omitted from an extended attribute of a directory, comparing a first passphrase of a first file and a second passphrase of a second file to produce a result, wherein the first file is identified by a request associated with the user account to write the first file to the directory, and wherein the second file is stored in the directory; and
based on the result indicating that the first passphrase matches the second passphrase,
adding the identification of the user account to the extended attribute of the directory, and
enabling operations, initiated from the user account, on the directory based on the extended attribute comprising the identification of the user account.

17. The non-transitory computer-readable medium of claim 16, wherein the second file is uneditable from the user account or another user account that is different from the user account.

18. The non-transitory computer-readable medium of claim 16, wherein the second file is viewable by a second user account with a secure administrator status, and wherein the second file is hidden from the user account.

19. The non-transitory computer-readable medium of claim 16, wherein the second file is stored in a known location in the directory.

20. The non-transitory computer-readable medium of claim 16, wherein the directory is a first directory, and wherein a second directory is protected with a third passphrase that differs from the second passphrase.
